(19) United States
(12) Patent Application Publication
(10) Pub. No.: US 2009/0116780 A1
(43) Pub. Date: May 7, 2009

(54) Bearing Systems

(76) Inventor: Clive Davis, Nottingham (GB)

Correspondence Address: Breiner & Breiner, P O Box 320160, Alexandria, VA, 22320-0160, US

(21) Appl. No.: 12/083,106

(22) PCT Filed: Sep. 29, 2006
(86) PCT No.: PCT/GB2006/003616

§ 371 Date: Apr. 4, 2008

(30) Foreign Application Priority Data
Oct. 5, 2005 (GB) 0520253.6

(51) Int. Cl. F16C 19/30

(52) U.S. Cl. 384/590

(57) ABSTRACT

Bearing arrangements are described which enable rotation about a vertical axis with a very extended diameter bearing, for example 20 meters diameter. A usually stationary base supports a rotating member, e.g. on a fluid cushion. Separately, a ring of radially adjustable arcuate surface support pads on an outer member acts against a cylindrical surface of an inner member. The adjustability of the radially movable support pads enables them to increase their thrust at parts of the circumferences of the bearing relative to others. This enables considerably smoother running to be achieved, both to compensate for the difficulties of producing complete circularity with a bearing diameter of substantial size, and for varying direction lateral loadings, e.g. as experienced by a vertical axis wind-driven turbine.

This invention relates to bearing systems, particularly though not exclusively to bearing systems suitable for use in cases where a large structure needs to be mounted to rotate about a vertical axis.

A specific example of such a scenario is a power-generating vertical axis wind turbine. In order to generate useful quantities of power, wind-driven turbines need to be fairly large and accordingly of substantial weight. A particular difficulty is that the greater the wind, and accordingly the greater the potential power output of a vertical axis wind turbine, the greater the lateral forces on the turbine structure itself and the greater the demands placed on the bearing arrangement.

The operation of vertical axis wind turbines where the turbine is relatively small can be satisfactorily effected using standard size engineering components. However, in the case of a large rotating body, standard bearing technology is impractical. This is particularly the case if the bearing arrangement is to have a substantial intrinsic diameter, for example 15 or 20 metres. Manufacturing a steel bearing ring of diameter 20 metres would be difficult but not impossible, but manufacturing one which was strictly geometrically accurate is essentially infeasible.

The present invention seeks to provide bearing arrangements which can be used to provide bearings for rotational movement about a vertical axis of substantial diameter, e.g. up to 30 metres or even higher.

According to a first feature of the present invention, there is provided a bearing arrangement for vertical axis rotation consisting of inner and outer coaxial cylindrical members, one member having a generally flat support surface transverse to its axis and the other member having a generally flat circular or annular surface facing the support surface on the one member, means for enabling the two flat support surfaces to rotate relative to one another, and wherein the cylindrical wall of one member carries a plurality of radially movable arcuately curved support plates, the curvature of the support plates matching the curvature of the facing surface of the other member, and being in contact therewith, and means to control the radial thrust exerted by the movable support plates on the cylindrical surface of the other member. The radial thrust is preferably directed inwardly, as this enables the machined surface (against which the arcuately curved plates press) to be of smaller diameter, and thus more easily machinable, than the inner diameter of the outer coaxial member.

Preferably the bearing arrangement includes at least ten and more preferably at least 20 such arcuate support plates, forming a ring. If desired, and if the axial extent of the bearing allows, there may be two or more rings of such arcuate support plates.

While the individual support plates may be on rotor or stator and may act to exert thrust radially inwardly or outwardly, it is generally most convenient to have the plates mounted on the stator since then the maintenance, operation and control of the entire bearing arrangement is generally easier.

The generally flat support surface transverse to the axis of rotation of the bearing may be made up of a number of individual surface members, each of which may be movable axially by means of an appropriate actuator. The axial thrust between that surface and the facing circular or annular surface of the other component may be transmitted by a cushion of fluid between them, constituting a hydrostatic bearing, or e.g. via needle rollers or other like force transmission members enabling rotation of one surface relative to the other. In the case of a fluid cushion support, this is most conveniently achieved if the supporting part of the bearing is stationary and consists of a plurality of individual support surfaces, each of which may be moved axially by a short distance and each of which support surfaces has means for forming a cushion of fluid above it on which part of the other member of the bearing rests. The axial movement of adjacent parts of the support surface is preferably controlled centrally by suitable control means to enable linked operation.

The bearing arrangement of the present invention is, as noted above, of particular value in the case of bearings where the loading is not purely axial, as, for example, is the case with a large vertical axis wind turbine where the rotating portion, which forms a solid rotating unit with the “sails” thereon, is set to rotate on or in a base, and which is subject to the lateral force of the wind. This places substantial demands on the bearing technology, which may be met by the use of bearing arrangements as set out above.

By way of illustration, the accompanying drawings show diagrammatically a bearing arrangement for use with a large size vertical axis wind turbine. While the invention is illustrated with reference to this field, it should be understood that the bearing arrangement of the present invention may be used in any other analogous situation where a very large diameter bearing is appropriate.

In the drawings:

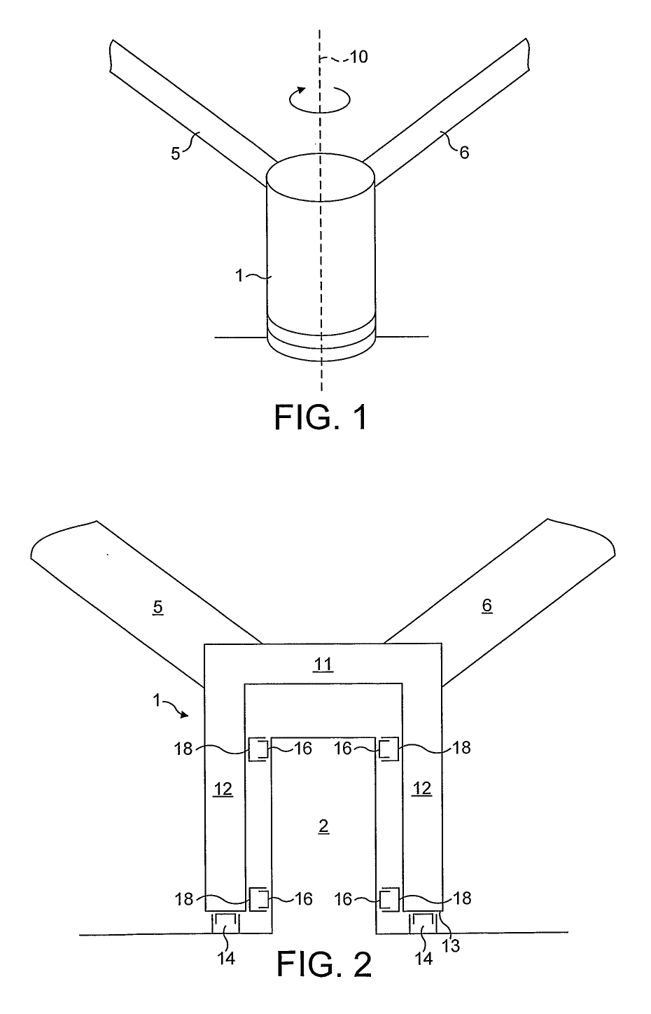

FIG. 1 is a simplified diagrammatic partial perspective view of a large vertical axis wind turbine installation.

FIG. 2 is a diagrammatic section through the installation of FIG. 1.

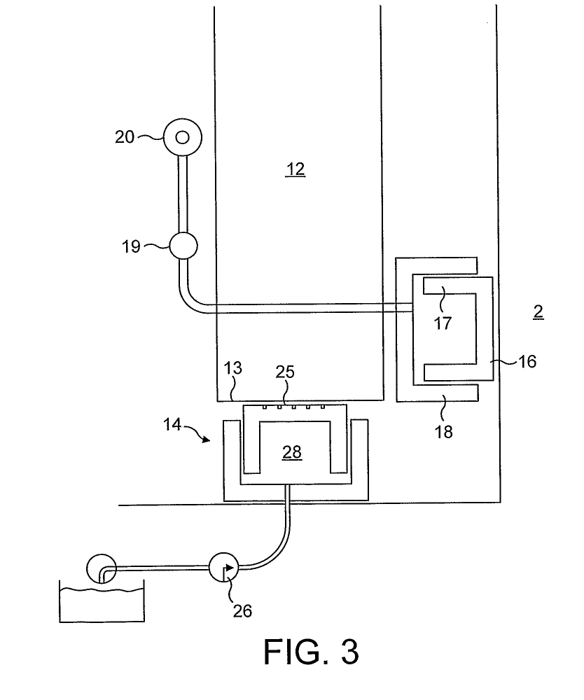

FIG. 3 is a diagrammatic part-section on a much larger scale showing part of the bearing arrangements used in the wind turbine installation shown in FIG. 1.

Referring first to FIG. 1, this shows a large vertical axis wind turbine. As can be seen, the turbine consists of a rotatable base 1 to the top of which are attached two inclined spars 5 and 6 extending upwardly and radially outwardly from the centre of base 1. Each spar carries a plurality of aerodynamic section short aerofoils. The spar and aerofoil construction is arranged such that when a wind blows laterally, the aerodynamic forces on the aerofoils tend to rotate the base 1 about its central vertical axis 10. The base 1 is mounted around a central column (not visible in FIG. 1) by means of a bearing system in accordance with the present invention.

As shown in FIG. 2, the base 1 is essentially hollow, and surrounds a central column 2 forming part of the fixed member of the bearing arrangement. Base 1 consists of a transverse circular top plate 11 and a depending skirt 12. The lower edge of depending skirt 12 is a flat face 13 which rests on a series of support pads 14 constituting an annular ring of support pads around the base of column 2. The upper surface of each support pad 14 is perforated and lubricant under high pressure may be pumped into each support pad and allowed to escape via the perforations in its upper surface. In so doing, it creates a fluid cushion between pad 14 and the underside of skirt 12, i.e. flat face 13, so as to support base 1 and allow it to rotate about column 2.

The inner cylindrical wall of the skirt 12 carries a plurality of arcuate support surfaces 16 which are set in two rings about the inside of base 1 and each of which may be moved radially by virtue of constituting the piston of an hydraulic piston/cylinder arrangement. As shown in FIG. 3, surface 16 is the face of a piston having a skirt 17 and being a sliding fit within a chamber 18. The pressure in chamber 18 may be controlled by a valve 19 which is connected to a hydraulic supply 20. Means may be provided to introduce a lubricant film between each of the arcuate support surfaces 16 and the outer surface of the column 2.

In order to even out the forces on the base and aerodynamic superstructure thereon, the pressures within the chambers 18 behind each of the arcuate support surfaces 16 may be suitably controlled. Conveniently, the pressure is relatively evenly applied around the circumference of the base member save for the fact that in order to offset the lateral force of the wind, the individual arcuate support surfaces 16 in the lower ring are loaded more towards from the wind, and those in the upper ring more away from the wind, which serves to keep the base 1 properly centred on base member 2 while rotating.

Control of the individual hydraulic chambers 18, each of which presses its respective arcuate support surface 16 against the cylindrical outer surface of the column 2 does not need to be on an individual basis. Rather, it is more appropriate to control the pressures in chambers 18 in groups, e.g. eight groups, each group extending around an octant. Within each group, it is also useful to connect the pressurised chambers together so that any irregularities in circularity can be compensated for as the base 1 rotates relative to the column 2.

The detailed control of the individual positions of support surfaces 16 is preferably carried out automatically by mechanisms which sense the position of the column 2 relative to skirt 12 and compare it to a desired position. If there is no deviation, then all of the surfaces 16 are pressed lightly on to the fixed surface of column 2 with a small but constant force.

As the pressure is constant around the rings of support surfaces 16, the bearing has no stiffness. If the control system detects that the distance between skirt 12 and the outer surface of column 2 has reduced, at a certain radial position, the chambers 18 behind the support surfaces 16, over a range of about 45° to either side of that position, are subjected to higher pressure, sufficient to offset the deviation. The surfaces 16 still share the load, even though sensing the force has caused their position to vary accordingly. The bearing is now stiff, but any surface irregularities are compensated by the load sharing mechanism imparted by connecting the chambers in groups.

If the direction of force changes, then the direction of the deviation of the skirt relative to the column will change and a different set of support surfaces 16 work together.

Vertically, the base 1 is supported by the skirt 12 resting on the support pads 14, each of which consists of a chamber 28 and a sealed piston pad 25, on which the skirt 12 rests (via the fluid cushion noted above). The position of pad 25 is controlled by a valve 26 which may allow oil under pressure to flow into chamber 28 or vent oil from the chamber, usually under central computerised control.

Although the bearing system of the invention has been described with reference to its use in a continuously rotating application, a wind-driven turbine, it may be applied in other areas, e.g. architectural areas where parts of large structures are to be rotated, for example swing bridges or observatory domes.

1-10. (canceled)

11. A bearing arrangement for vertical axis rotation comprising inner and outer coaxial cylindrical members, a first one of said members having a substantially flat support surface transverse to an axis thereof and a second one of said members having a substantially flat circular or annular surface facing the support surface on the first one of said members, means for enabling the flat support surface and the flat circular or annular surface to rotate relative to one another, and wherein a cylindrical wall of the first one of said members carries a plurality of radially movable arcuately curved support plates, curvature of the support plates matching curvature of a facing surface of the second one of said members, and being in contact therewith, and means to control radial thrust exerted by the movable support plates on the cylindrical surface of the second one of said members.

12. The bearing arrangement according to claim 11, wherein the radial thrust is directed inwardly.

13. The bearing arrangement according to claim 11, including at least ten of said arcuately curved support plates forming a ring.

14. The bearing arrangement according to claim 12, including at least ten of said arcuately curved support plates forming a ring.

15. The bearing arrangement according to claim 13, including at least two rings formed of said arcuately curved support plates.

16. The bearing arrangement according to claim 14, including at least two rings formed of said arcuately curved support plates.

17. The bearing arrangement according to claim 11, wherein the movable support plates constitute a stator, and the second one of said members constitute a rotor.

18. The bearing arrangement according to claim 11, wherein the substantially flat support surface transverse to the axis of rotation of the bearing comprises a plurality of individual surface members and the bearing arrangement further includes actuators arranged to move each surface member.

19. The bearing arrangement according to claim 18, wherein axial thrust between the substantially flat support surface and a facing circular or annular surface of the second one of said members is transmittable by a cushion of fluid present therebetween, constituting a hydrostatic bearing enabling rotation of one surface relative to another surface.

20. The bearing arrangement according to claim 11, wherein a part of the bearing including the substantially flat support surface is stationary and includes a plurality of individual support surfaces, each of which may be moved axially a short distance and each of which support surfaces has means for forming a cushion of fluid above it on which part of the second one of said members of the bearing rests.

21. The bearing arrangement according to claim 20, wherein axial movement of adjacent parts of the support surface is controlled centrally by control means which enable linked operation.

22. The bearing arrangement according to claim 11, in combination with and incorporated in a vertical axis wind turbine.
